(19) United States
(12) Patent Application Publication
(10) Pub. No.: US 2022/0123517 A1
(43) Pub. Date: Apr. 21, 2022

(54) OPTICAL FIBER DEVICES AND METHODS FOR REDUCING STIMULATED RAMAN SCATTERING (SRS) LIGHT INTENSITY IN SIGNAL COMBINED SYSTEMS

(71) Applicant: nLIGHT, Inc., Camas, WA (US)

(72) Inventors: Tyson L. Lowder, Vancouver, WA (US); Dahv A.V. Kliner, Portland, OR (US); C. Geoffrey Fanning, Portland, OR (US)

(73) Assignee: nLIGHT, Inc., Camas, WA (US)

(21) Appl. No.: 17/418,705

(22) PCT Filed: Dec. 19, 2019
(86) PCT No.: PCT/US2019/067548

§ 371 Date: Jun. 25, 2021

Related U.S. Application Data
(60) Provisional application No. 62/786,179, filed on Dec. 28, 2018.

(51) Int. Cl. H01S 3/23; H01S 3/30; H01S 3/067

(52) U.S. Cl. CPC H01S 3/2391; H01S 3/302; H01S 2301/03; H01S 3/06754; H01S 3/0675

(57) ABSTRACT

Signal combined optical fiber devices, systems, and methods for reducing signal spectrum pumping of Raman spectrum. Power of a Raman component in an output of a signal combined fiber laser system may be reduced by diversifying peak signal wavelengths across a plurality of signal generation and/or amplification modules that are input into a signal combiner. In some examples, fiber laser oscillators that are to have their output signals combined to reach a desired cumulative system output power are tuned to output signal bands of sufficiently different wavelengths that signal from separate ones of the oscillators do not collectively pump a single Raman band. With the combined signal component comprising different peak signal wavelengths, the Raman component of combined output may have multiple peak wavelengths and significantly lower power than in systems where signals of substantially the same signal peak wavelength are combined.

### CLAIM FOR PRIORITY

This application claims priority to U.S. Provisional Patent Application Ser. No. 62/786,179, filed on Dec. 28, 2018 and titled “Optical Fiber Devices and Methods for Reducing Stimulated Raman Scattering (SRS) Light Intensity in Signal Combined Systems”, which is incorporated by reference in its entirety.

### BACKGROUND

The fiber laser industry continues to increase laser performance metrics, such as average power, pulse energy and peak power. Pulse energy and peak power are associated with the storage and extraction of energy in the fiber while mitigating nonlinear processes that can have adverse impacts on the temporal and spectral content of the output pulse. Stimulated Raman Scattering (SRS) light is the result of one such nonlinear process associated with vibrations of the fiber media (e.g., glass). SRS is typically an undesired byproduct of fiber laser and/or fiber amplifier signal light passing through the optical fibers that these systems comprise.

Generation of SRS light can reduce power in an intended signal output wavelength. SRS generation can also destabilize laser emission resulting in undesired output power fluctuations. SRS generation may also have detrimental effects on the spatial profile of laser system emission. SRS may also be re-introduced in laser and amplifier systems by reflections from objects internal to, or external to, the laser system, such as optics used to manipulate the laser or amplifier output, or the workpiece to which the laser light output is applied. Such reflections can also destabilize the laser emission. Once generated, a laser and/or amplifier of a fiber system may amplify SRS light to the point of causing catastrophic damage to components internal to the system (e.g., a fiber laser, or fiber amplifier). The SRS light may also be detrimental to components external to the fiber system because the external components may not be specified for the wavelength of the SRS light. This mismatch in wavelength between what is delivered versus what is expected can lead to undesirable performance at the workpiece or may cause an eye safety concern for the external system in which the fiber system was integrated. As such, it may be desirable to suppress SRS generation within a fiber system, remove SRS light from a fiber system, and/or otherwise mitigate one or more of the undesirable effects of SRS light.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a graph illustrating a non-linear relationship between the optical power of a Raman component and a signal component of a light beam propagated in a fiber, in accordance with some embodiments;

FIG. 2 is a flow chart illustrating methods of combining diversified signal bands for reduced Raman component power, in accordance with some embodiments;

FIG. 3A is a schematic of a fiber device for combining diversified signal bands for reduced Raman component power, in accordance with some embodiments;

FIGS. 3B and 3C are longitudinal and transverse cross-sectional views of a fiber, in accordance with some embodiments;

FIG. 4 is a flow chart illustrating methods of combining signals generated with diversified fiber oscillators for reduced Raman component power, in accordance with some embodiments;

FIG. 5 is a schematic of a signal-combined fiber laser system having reduced Raman spectrum pumping, in accordance with some embodiments; and

FIG. 6 is a schematic of a signal-combined MOPA system having reduced Raman spectrum pumping, in accordance with some embodiments.

### DETAILED DESCRIPTION

One or more embodiments are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that the present invention may be practiced without these specific details. In some instances, well-known methods and devices are shown in block diagram form, rather than in detail, to avoid obscuring the present invention. Reference throughout this specification to “an embodiment” or “one embodiment” means that a particular feature, structure, function, or characteristic described in connection with the embodiment is included in at least one embodiment of the invention. Thus, the appearances of the phrase “in an embodiment” or “in one embodiment” in various places throughout this specification are not necessarily referring to the same embodiment of the invention. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause an effect relationship).

The terms “over,” “under,” “between,” and “on” as used herein refer to a relative position of one component or material with respect to other components or materials where such physical relationships are noteworthy.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

The term “luminance” is a photometric measure of the luminous intensity per unit area of light travelling in a given direction. The term “numerical aperture” or “NA” of an optical system is a dimensionless number that characterizes the range of angles over which the system can accept or emit light. The term “optical intensity” is not an official (SI) unit, but is used to denote incident power per unit area on a surface or passing through a plane. The term “power density” refers to optical power per unit area, although this is also referred to as “optical intensity” and “fluence.” The term “radial beam position” refers to the position of a beam in a fiber measured with respect to the center of the fiber core in a direction perpendicular to the fiber axis. The term “radiance” is the radiation emitted per unit solid angle in a given direction by a unit area of an optical source (e.g., a laser). Radiance may be altered by changing the beam intensity distribution and/or beam divergence profile or distribution. The term “refractive-index profile” or “RIP” refers to the refractive index as a function of position along a line (1D) or in a plane (2D) perpendicular to the fiber axis. Many fibers are azimuthally symmetric, in which case the 1D RIP is identical for any azimuthal angle. The term “optical power” is energy per unit time, as is delivered by a laser beam, for example. The term “guided light” describes light confined to propagate within an optical waveguide. The term “cladding mode” is a guided propagation mode supported by a waveguide within one or more cladding layers of an optical fiber. The term “core mode” is a guided propagation mode supported by a waveguide within one or more core layers of an optical fiber. The term “multimodal” means a distribution having more than one peak. In contrast, a unimodal power spectrum has only one peak. A bimodal power spectrum is a multimodal spectrum that specifically has two peak powers, for example. The peaks of a multimodal response may have different magnitudes.

Described herein are optical fiber devices, systems, and methods suitable for one or more of suppressing SRS generation within a fiber system, removing SRS light from a fiber system, and/or otherwise mitigating one or more undesirable effects of SRS within a fiber system.

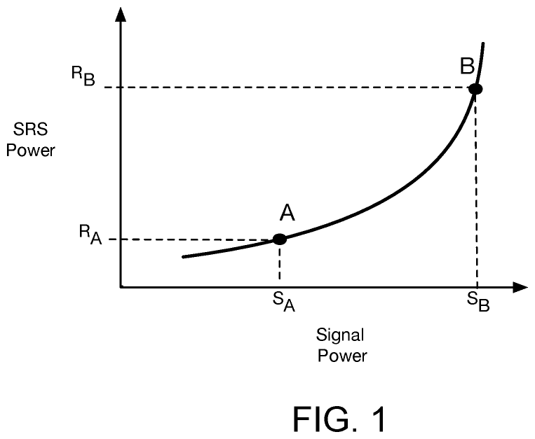

FIG. 1 is a graph illustrating a non-linear relationship between the optical power of a Raman component and a signal component of a light beam propagated in a fiber, in accordance with some embodiments. Optical power of a peak wavelength of a signal component of a light beam propagated through a given length of representative optical fiber is shown on the independent axis. Optical power of a peak wavelength of a stimulated Raman scattering component of the light beam is shown on the dependent axis. In FIG. 1, optical power may have any arbitrary unit (e.g., W). As shown, optical power at the peak Raman wavelength increases according to an exponential function of the signal component power, which pumps, or stimulates, the Raman component as the beam is propagated in the fiber. A similar exponential increase in power can be expected with an increase fiber length for fixed power. Because of the non-linear relationship between the Raman and signal components, fiber system architectures designed to operate at low to moderate power point A may not be readily scalable for operation at an arbitrarily high power point B. For example, if two fiber laser modules of substantially identical configuration, each suitable for achieving signal power S_{A}, were assembled into a system in which their output signals are combined to operate a system at a high power point B, the Raman component R_{B} may now be amplified within the system to an intolerably high power level.

In accordance with some embodiments described further herein, the modular architecture of signal-combined fiber systems is leveraged to effectively reduce the pumping of Raman spectrum by signal spectrum. As described below, power of a Raman component in an output of a signal-combined fiber laser system may be reduced through the diversification of peak signal wavelengths across a plurality of signal generation and/or amplification modules that are input into a signal combiner. In some exemplary embodiments, fiber laser oscillators that are to have their output signals combined to reach a desired system output power are tuned to output signal bands of sufficiently different wavelengths such that the output signal from separate ones of the oscillators do not collectively pump a single Raman band. Instead, the diversified signal spectrums combine into a signal component comprising multiple (different) peak signal wavelengths. The resulting Raman component of a combined output beam may therefore also have multiple peak wavelengths, each associated with individual ones of the diversified signal bands. As such, resulting Raman power levels associated with the combined signals may be significantly lower than for systems where signals of substantially the same peak wavelength are combined.

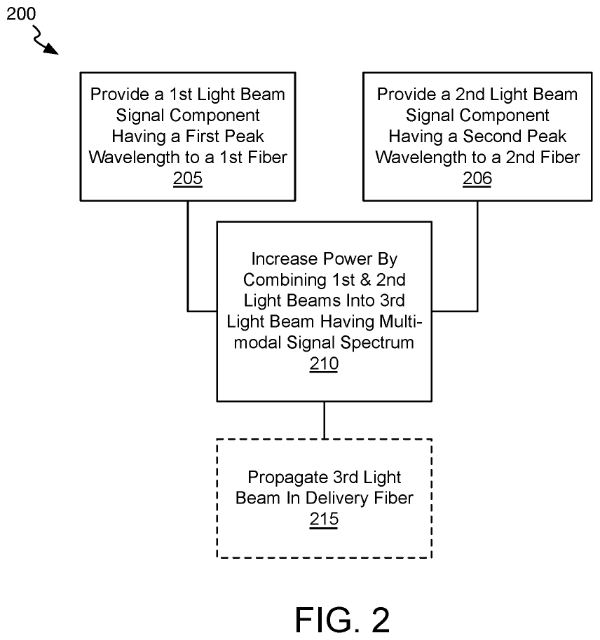

FIG. 2 is a flow chart illustrating methods 200 suitable for combining diversified signal bands for reduced Raman component power, in accordance with some embodiments. Methods 200 begin at block 205 where a first light beam is provided to a first fiber. The light beam may be provided at block 205 through any means known to be suitable for a fiber system, for example with free-space optics that provide the beam incident to an end of the fiber, or with fiber-based optics that are coupled into the fiber. The first light beam has a signal component Iₛ₁. The signal component Iₛ₁ may have any range of optical power per frequency or wavelength (W/nm) over a predetermined first signal power spectrum comprising. The first signal power spectrum may be associated with a peak wavelength λₛ₁ of maximum optical power. The first signal spectrum may have any band characteristics, and may, for example, comprise a band known to be suitable for continuous wave (CW) and/or pulsed fiber laser systems (e.g., with a micrometer peak wavelength λₛ₁, such as 1080 nm, etc.). In some exemplary embodiments, the signal component Iₛ₁ has a unimodal spectrum having a single peak power. The peak wavelength λₛ₁ may be a center wavelength of the single-peaked spectrum, for example. The signal component Lₛ₁ may have any optical power, for example where SRS begins to be an issue for a given system and/or application. In some exemplary fiber laser embodiments the signal component Iₛ₁ has a power of at least 0.5 kW, advantageously at least 1 kW, and more advantageously at least 2 kW. Although such power levels are found in power laser applications (e.g., materials processing), SRS can also pose an issue at significantly lower powers however, particularly for smaller mode field diameters (e.g., smaller core fiber) and/or long lengths of fiber (e.g., kilometer telecom lengths).

Within the first fiber, the first light beam may further comprise a first Raman component Iᵣ₁. The Raman component Iᵣ₁ may be present in a light beam incident to the first fiber, and/or may be developed within the first fiber, for example as a result of scattering phenomena associated with the first fiber, for example. The Raman component Iᵣ has some range of some power per frequency or wavelength (W/nm) over a Raman power spectrum comprising one or more Raman wavelengths. The Raman power spectrum may be associated with a peak wavelength λᵣ₁ of maximum optical power. The Raman component Iᵣ₁ spans wavelengths shifted longer from those of the first signal component Iₛ₁. The Raman component Iᵣ₁ may have a broader band than signal component Iₛ₁, for example as a result of noise and the wide gain bandwidth of SRS. In some illustrative embodiments where the first signal component Iₛ₁ has a peak wavelength λₛ₁ of 1080 nm, the derivative Raman component Iᵣ₁ may have Raman peak wavelength λᵣ₁ around 1130 nm. The power of the Raman peak wavelength λᵣ₁ may vary as a function of the signal power spectrum that stimulates the first Raman component Iᵣ₁.

At block 206 a second light beam is provided to a second fiber. The second light beam may be provided at block 206 through any means known to be suitable for a fiber system, for example with free-space optics that provide the beam incident to an end of the fiber, or with fiber-based optics that are coupled into the fiber. In some exemplary embodiments, the second light beam is provided at block 206 in substantially the same manner that the first light beam is provided at block 205.

The second light beam has a signal component Iₛ₂. The signal component Iₛ₂ may have any range of optical power over a predetermined second signal power spectrum comprising one or more signal wavelengths different than the first signal power spectrum. For example, the second signal power spectrum may be associated with a peak wavelength λₛ₂ of maximum optical power. Peak wavelength λₛ₂ is advantageously separated from peak wavelength λₛ₁ by an amount sufficient to ensure the second signal component Iₛ₂, when at a sufficient power, will stimulate a second Raman component Iᵣ₂ that is of a different band than the first Raman component Iᵣ₁. The second signal spectrum may again have any band characteristics, and may, for example, comprise another band known to be suitable for continuous wave (CW) and/or pulsed fiber laser systems (e.g., with a micrometer first peak wavelength λₛ₂, such as 1060 nm, etc.). In some exemplary embodiments, the signal component Iₛ₂ also has a unimodal spectrum characterized by a single peak. The peak wavelength λₛ₂ may be a center wavelength of the second signal spectrum, for example. Although the signal component Iₛ₂ may also have any optical power, in some exemplary fiber laser embodiments the signal component Iₛ₂ has a power of at least 0.5 kW, advantageously at least 1 kW, and more advantageously at least 2 kW. In some further embodiments, the signal component Iₛ₂ has substantially the same power as the signal component Iₛ₁ provided at block 205.

Within the second fiber, the second light beam may further comprise a second Raman component Iᵣ₂. This second Raman component Iᵣ₂ may again be present in a light beam incident to the second fiber, and/or may develop as the second beam propagates within the second fiber, for example as a result of scattering phenomena associated with the second fiber. The Raman component Iᵣ₂ may have any range of optical power over a Raman power spectrum comprising one or more Raman wavelengths. The second Raman power spectrum may be associated with a second peak wavelength λᵣ₂ of maximum optical power. The Raman component Iᵣ₂ will again span wavelengths shifted longer than those of the second signal component Iₛ₂. For example, where the signal component Iₛ₂ has a first peak wavelength λₛ₂ of 1060 nm, the Raman component Iᵣ₂ may have Raman peak wavelength λᵣ₂ of around 1110 nm. The Raman component Iᵣ₂ may have a broader band than the signal component Iₛ₂, for example as a result of noise. The power of the Raman peak wavelength λᵣ₂ may again vary as a function of the signal power that stimulates the second Raman component Iᵣ₂.

Methods 200 continue at block 210 where the first and second light beams propagated in the first and second fibers, respectively, are combined into a third light beam propagated in a third fiber. The first and second light beams may be combined in any manner known to be suitable for maintaining coherency of the first light beam and maintaining the coherency of the second light beam (the combined result is an incoherent combination where the intensities of the first and second beams are added together rather than their field components). Outputs of the first and second lasers may be incoherently combined while maintaining the individual coherence of each laser. Block 210 may be implemented with any suitable signal combiner employing fiber-based techniques, or alternative techniques enlisting free-space optics. In exemplary embodiments where first and second signal components Iₛ₁, Iₛ₂ have different peak wavelengths λₛ₁, λₛ₂, respectively, the combination of the first and second light beams cause the resultant output light beams to have a multimodal, or multi-peaked signal component Iₛ₃. Where the signal components Iₛ₁, Iₛ₂ provided at blocks 205 and 206 each have a single peak, a bimodal (two-peaked) signal component having peak wavelengths λₛ₁, λₛ₂ may be generated by the signal-combining at block 210. The power of the signal component Iₛ₃ exceeds that of either signal components Iₛ₁, Iₛ₂, and may be any summation function of the input optical powers (e.g., slightly less than the summed input powers by some efficiency factor associated with the act of combining the signals). In some exemplary embodiments where the power of Iₛ₁ is approximately equal to the power Iₛ₂, the power of signal component Iₛ₃ is approximately twice the power of Iₛ₁(Iₛ₂). Hence, where each of Iₛ₁, Iₛ₂ is over 1 kW, Iₛ₃ may be over 2 kW.

Raman components Iᵣ₁, Iᵣ₂, if present within the first light beam and/or second light beam, are also combined at block 210. Since each Raman component Iᵣ₁, Iᵣ₂ comprises a different stimulated band (e.g., with Raman peak wavelengths λᵣ₁, λᵣ₂), the Raman component Iᵣ₃ of the combined output light beams may be multimodal. When the signal components Iₛ₁, Iₛ₂ provided at blocks 205 and 206 are unimodal, signal-combining at block 210 may generate a bimodal Raman component having peak wavelengths λᵣ₁, λᵣ₂. For embodiments where the signal components Iₛ₁, Iₛ₂ are sufficiently separated, the peak power at each of signal peak wavelengths λₛ₁, λₛ₂ is independent of the signal combination implemented at block 210. A dramatic increase in pumping of either Raman component Iᵣ₁ or Iᵣ₂ within the third fiber can therefore be avoided. Instead, the Raman component Iᵣ₃ will have some power that is a function (e.g., power law or exponential) of less than a sum of the optical powers of the signal components Iₛ₁, Iₛ₂. Signal pumping of Raman component Iᵣ₁ within the third fiber may remain a function (e.g., power law or exponential) of the power of only one portion of the spectrum in signal component Iₛ₃ attributable to signal component Iₛ₁. Signal pumping of Raman component Iᵣ₂ within the third fiber may remain a function (e.g., power law or exponential) of the power of only the portion of the spectrum in signal component Iₛ₃ attributable to signal component Iₛ₂.

The amount by which signal components Iₛ₁, Iₛ₂ are to be separated may vary according to a transfer function relating the signal spectrums to their respective Raman spectrums. Separation between signal components Iₛ₁, Iₛ₂ may need to be greater where the Raman spectrums broaden more from their respective signal spectrums to ensure there is no significant pumping of Iᵣ₁ by Iₛ₂, and no significant pumping of Iᵣ₂ by Iₛ₁. Once Raman shift is characterized for a given fiber and signal power, the signal bands for blocks 205 and 206 may be set to provide beams of predetermined peak wavelengths that ensure the signal components combine at block 210 with a reduced combined Raman component relative to a combination of signal components sharing substantially the same spectrum. An upper bound on wavelength separation between the operating points for blocks 205 and 206 may be limited by one or more of beam generation performance, fiber propagation performance, or suitability of the third light beam for a given application/use.

Separation of signal spectrums Iₛ₁, Iₛ₂ may be relatively small, for example less than the Raman shift between one pumping signal spectrum (e.g., Iₛ₁) and the corresponding Raman spectrum (e.g., Iᵣ₁), which may be around 50 nm. In some exemplary embodiments where each of Iₛ₁, Iₛ₂ are unimodal, their peak wavelengths are separated by at least 5 nm, and advantageously 10 nm, or more. Wavelength separation between individual sources may be so small as peak power as a function of wavelength falls off rather quickly (i.e. a Gaussian or Lorentzian shape spectrum). For one illustrative embodiment where λₛ₁ and λₛ₂ are approximately 1060 nm and 1080 nm, respectively, and the power of the signal component Iₛ₁ is approximately equal to the power of the signal component Iₛ₂, power of a signal-combined bimodal Raman component having peak wavelengths λᵣ₁, λᵣ₂ may be approximately half the power the Raman component would have if λₛ₁ and λₛ₂ were instead substantially identical (e.g., both 1070 nm).

Methods 200 illustrate one material processing application where the third light beam is further propagated in a delivery fiber at block 215. To emphasize that there are many other applications where blocks 205, 206 and 210 may be performed, block 215 is illustrated in dashed line as being an optional application-specific end point for methods 200. Although the combination of two signals of differing peak signal wavelengths are illustrated by methods 200, three or more signals may be combined in substantially the same manner as described for the combination of two signals.

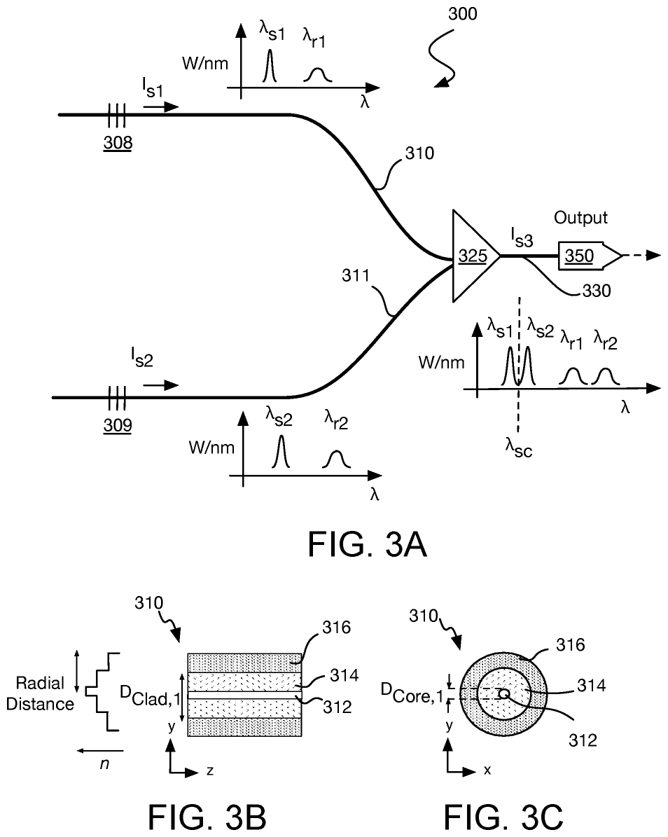

FIG. 3A is a schematic of a fiber device 300 suitable for combining diversified signal bands for reduced Raman component optical power, in accordance with some embodiments. Device 300 may perform methods 200, for example. As shown, fiber device 300 includes an optical wavelength filter 308 coupled to provide a light beam to a fiber 310. Wavelength filter 308 may be any device known to be suitable as a bandpass filter of any given light beam incident to filter 308. For example, filter 308 may be a fiber grating (FG) filter or Brillouin scatter filter, tuned to have highest transmission at peak signal wavelength λₛ₁ of the representative signal power spectral density (PSD) graph also illustrated in FIG. 3A. Fiber device 300 further includes another optical wavelength filter 309 optically coupled to a fiber 310. Wavelength filter 309 may also be any device known to be suitable as a bandpass filter of any given light beam incident to filter 308. In some exemplary embodiments, filter 309 is also a FG filter, or Brillouin scatter filter, but is tuned to have highest transmission at peak signal wavelength λₛ₂ of the representative signal PSD graph further illustrated in FIG. 3A.

Filters 308, 309 may have a variety of architectures capable of coupling a target spectral bandwidth (e.g., signal component Iₛ₁) into fibers 310, 311, respectively. For fiber grating embodiments, refractive index (RI) perturbations are present within at least a fiber core over some grating length. In some examples where a grating is within a double-clad fiber, RI perturbations within the fiber core have a refractive index n₄ that is higher than a nominal core index n₃. RI perturbations of a fiber grating may impact light guided within a fiber core over a target range of wavelengths while light outside of the target band may be substantially unaffected by RI perturbations such that the grating may be tuned to pass a desired signal band. The fiber grating period may vary, from around half of a peak signal wavelength for a fiber Bragg grating (FBG), to many times that for a long period fiber grating (LPFG). In some examples where the peak signal wavelengths λₛ₁ λₛ₂ are 1000 nm, or more, grating period is 500 nm, or more. In some other embodiments, grating period ranges from 100-1000 μm. FBG or LPFG filter embodiments may have a fixed period, be aperiodic (i.e., chirped), or apodized, and may be slanted or orthogonal to a longitudinal fiber axis. Super-structured gratings are also possible.

The light beam propagated through filter 308 comprises signal component Iₛ₁ of sufficient power to induce Raman component Iᵣ₁, which may grow over a propagation length of fiber 310. The light beam propagated through filter 309 comprises signal component Iₛ₂ of sufficient power to induce Raman component Iᵣ₂, which grows over a propagation length of fiber 311. In FIG. 3A, peak Raman wavelengths λᵣ₁, λᵣ₂ are further illustrated for representative PSD graphs for the Raman components propagating within fibers 310, 311.

Within fibers 310, 311 the signal component Iₛ and the Raman component Iᵣ may each propagate in a core guided mode lm₁, for example. In some examples, the core guided mode is a linear polarized mode LPₗₘ, with one embodiment being the linearly polarized fundamental transverse mode of the optical fiber core, LP₀₁. LP₀₁ has desirable characteristics in terms of beam shape, minimal beam expansion during propagation through free space (often referred to as “diffraction limited”), and optimum focus-ability. Hence, fundamental mode LP₀₁ propagation is often advantageous in the fiber laser industry.

Fibers 310 and 311 may each have any architecture known to be suitable for a fiber-based signal combiner. FIGS. 3B and 3C are longitudinal and transverse cross-sectional views of fiber 310, respectively, in accordance with some multi-clad fiber embodiments. Although a double clad fiber embodiment is illustrated, fiber 310 may have any number of cladding layers (e.g., triple, etc.) known to be suitable for supporting a cladding mode in optical fiber. Single clad embodiments of fibers 310 and 311 are also possible. In the example illustrated in FIGS. 3B and 3C, fiber 310 has a central core 312, and an inner cladding 314, which is annular and encompasses core 312. An annular outer cladding 316 surrounds inner cladding 314. Core 312 and inner cladding 314 may have any suitable composition (e.g., glass). Outer cladding 316 may be a polymer or also glass, for example. Although not depicted, one or more protective (non-optical) coatings may further surround outer cladding 316.

Fiber 310 may have any suitable refractive index profile (RIP). As used herein, the “refractive-index profile” or “RIP” refers to the refractive index as a function of position along a line (e.g., x or y axis in FIG. 3C) or in a plane (e.g. x-y plane in FIG. 3C) perpendicular to the fiber axis (e.g., z-axis in FIG. 3B). In the example shown in FIG. 3B, the RIP is radially symmetric, in which case the RIP is identical for any azimuthal angle. Alternatively, for example as for birefringent fiber architectures, the RIP may vary as a function of azimuthal angle. Core 312, inner cladding 314, and outer cladding 316 can each have any RIP, including, but not limited to, a step-index and graded-index. A “step-index fiber” has a RIP that is substantially flat (refractive index independent of position) within fiber core 312. Inner cladding 314 may also have a substantially flat RI over D_{Clad,1}, with a RIP of fiber 310 stepped at the interface between core 312 and inner cladding 314. An example of one illustrative stepped RIP suitable for a fiber laser is shown in FIG. 3A. Alternatively, one or more of core 312 and inner cladding 314 may have a “graded-index” in which the RI varies (e.g., decreases) with increasing radial position (i.e., with increasing distance from the core and/or cladding axis).

In accordance with some embodiments, core 312 is suitable for multi-mode propagation of light. With sufficient core diameter D_{core,1}, and/or numerical aperture (NA) contrast, fiber 310 will support the propagation of more than one transverse optical mode within core 312. In other embodiments, core 312 has a diameter and NA sufficient to support only the propagation of a single (fundamental) transverse optical mode. In some exemplary embodiments, the core diameter D_{Core,1} is in the range of 10-100 micron (μm) and the inner cladding diameter D_{Clad,1} is in the range of 200-1000 μm, although other values for each are possible. Although core 312 and inner cladding 314 is illustrated as being concentric (i.e., a centered core), they need not be. One or more of core 312 inner cladding 314 may also be a variety of shapes other than circular, such as, but not limited to annular, polygonal, arcuate, elliptical, or irregular. Core 312 and inner cladding 314 in the illustrated embodiments are co-axial, but may alternatively have axes offset with respect to one another. Although D_{Clad,1} and D_{Core,1} are illustrated to be constants about a central fiber axis in the longitudinal direction (z-axis in FIG. 3B). The diameters D_{Clad,1} and D_{Core,1} may instead vary over a longitudinal length of fiber 310.

In further reference to device 300 (FIG. 3A), fiber 311 may have any of the properties described above for fiber 310. In some embodiments, fiber 311 has substantially the same core and cladding architecture as fiber 310. For example, fiber 311 may also comprise double-clad fiber. Fiber 311 may be substantially identical to fiber 310, for example having the same core and cladding architecture, composition(s), and dimension(s) (e.g., diameters).

Returning to FIG. 3A, fibers 310 and 311 are optically coupled to separate inputs of a signal-combiner 325. Signal-combiner 325 may have any architecture as embodiments herein are not limited in this respect. In some examples, signal-combiner 325 is fiber-based, lacking any free-space optics, for example. As shown, an output of signal-combiner 325 is further coupled to a fiber 330, which may have any of the attributes described above in the context of fiber 310. In some embodiments, fiber 330 is substantially the same as at least one of fibers 310 and 311. In some further embodiments, fibers 310, 311 and 330 all have substantially the same architecture and may further have in common their composition(s) and dimension(s). Alternatively, fiber 330 may have at least a different dimension than fiber 310 and/or 311. For example fiber 330 may have a different (e.g., larger) core diameter than that of fibers 310 and 311. Fiber 330 may further have a different (e.g., smaller) cladding diameter than that of fibers 310 and 311.

Although only two input fibers 310, 311 are illustrated in FIG. 3A, three, four, or more such fibers may be similarly optically coupled to an input port of signal combiner 325. Each additional input fiber may propagate an input light beam of a distinct wavelength to maintain the diversity described above in the context of fiber 310 and 311. For examples with an even number of input fibers (e.g., two), peak signal wavelengths (e.g., λₛ₁ of 1160 nm and λₛ₂ of 1180 nm) may be provided so as to equally straddle a predetermined target signal center wavelength (e.g., 1170 nm). A representative PSD graph for the combined signal Iₛ₃ illustrated in FIG. 3A shows the signal power spectrum comprising two peaks at λₛ₁ λₛ₂ centered about λ_{sc}, and the concomitant double-peaked Raman power spectrum. For examples with an odd number of input fibers (e.g. three), peak signal wavelengths (e.g., λₛ₁ of 1155 nm, λₛ₃ of 1170 nm, and λₛ₂ of 1185 nm) may be provided so as to provide the target center wavelength of the combined output in one input to the signal combiner, and equally straddle the target wavelength (e.g., 1170 nm) in two or more of the remaining inputs to the signal combiner.

As further shown in FIG. 3A, fiber 330 is optically coupled to a process head 350, from which the combined light beam is launched into free space (as represented by a dashed arrow). For such embodiments, fiber 330 is functionally a delivery fiber that may have considerable length over which the Raman components may be stimulated.

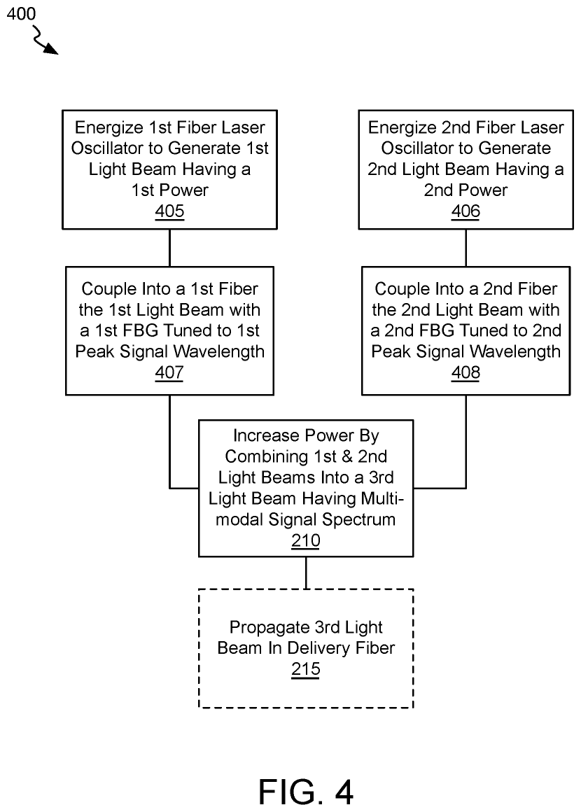

FIG. 4 is a flow chart illustrating methods 400 for combining signals generated with wavelength diversified oscillators for reduced combined Raman component power, in accordance with some embodiments. Methods 400 may be performed by signal-combined laser systems employing multiple laser oscillators and/or optical amplifiers, for example. Methods 400 may be practiced as a specific implementation of methods 200, described above.

Methods 400 begin at block 405 where a first fiber laser oscillator is energized to generate a first light beam of a predetermined power. A second fiber laser oscillator is energized to generate a second light beam of a predetermined power at block 406. Any fiber pumping techniques and/or resonant fiber cavity designs may be employed at blocks 405 and 406 to generate the respective light beams. In addition to originating a beam, one or more stage of optical amplification may also be implemented at blocks 405, 406. For example, a first master oscillator and power amplifier (MOPA) module may be configured to implement block 405 and a second MOPA module may be configured to implement block 406.

Methods 400 proceed to blocks 407 and 408 where the light beams of different peak signal wavelengths are coupled out of the fiber oscillators. In some exemplary embodiments, a fiber grating (e.g., a FBG) is employed as an output coupler. The fiber gratings may have transmission peaks tuned to most efficiently couple out different target signal peak wavelengths λₛ₁ λₛ₂, for example substantially as described for methods 200 in the more general context of coupling two incident beams into separate fibers. Methods 400 continue at block 210 where the two signal spectrums are combined to have a multi-peaked spectrum, for example substantially as described above for block 210 in the context of methods 200. Methods 400 may also terminate at an application specific endpoint where the signal combined light beam is propagated to any suitable destination, for example propagated in a delivery fiber and/or to a process head.

For the sake of clarity, methods 400 illustrate the combination of a minimum set of two signals of differing peak signal wavelengths. However, three or more input signals (each with different peak wavelengths) may be combined in substantially the same manner, for example to achieve higher signal-combined output powers.

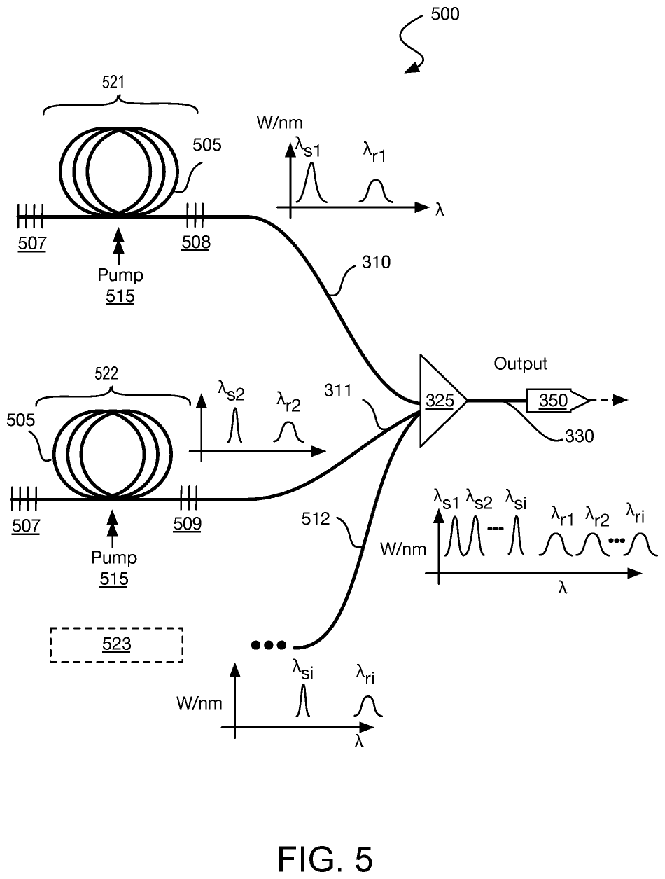

FIG. 5 is a schematic of a signal-combined fiber laser system 500 having reduced Raman spectrum pumping, in accordance with some embodiments. Fiber laser system 500 may implement methods 400, for example. System 500 includes a fiber laser oscillator 521 that is to generate a first optical beam by exciting a first signal spectrum of light. Oscillator 521 comprises an optical cavity defined by a strong fiber grating 507, and an output coupler 508 with a length of doped fiber 505 therebetween. Doped fiber 505 may comprise a variety of materials, such as, SiO₂, SiO₂ doped with GeO₂, germanosilicate, phosphorus pentoxide, phosphosilicate, Al₂O₃, aluminosilicate, or the like, or any combinations thereof. In some embodiments, the dopants comprise rare-earth ions such as Er³⁺ (erbium), Yb³⁺ (ytterbium), Nd³⁺ (neodymium), Tm³⁺ (thulium), Ho³⁺ (holmium), or the like, or any combination thereof. Doped fiber 505 may comprise a multi-clad fiber, for example substantially as described above for fiber 310. Doped fiber 505 may alternatively comprise a single-clad fiber, or any other fiber architecture known to be suitable for a resonant fiber cavity. Fiber oscillator 521 is optically coupled to a pump light source 515, which may be a solid state diode laser, or lamp, for example. Where fiber oscillator 521 comprises a multi-clad fiber, pump light source 515 may be coupled into a cladding layer of doped fiber 505 in either a co-propagating or counter-propagating manner. In some embodiments, doped fiber 505 comprises multi-mode fiber supporting multiple propagation modes within a fiber core (e.g., substantially as described above for fiber 310). However, in some alternative embodiments doped fiber 505 comprises a single-mode fiber capable of supporting only one propagation mode within the fiber core.

Output coupler 508 may be any reflective grating suitable for selectively coupling signal spectrum of a predetermined peak wavelength (e.g., λₛ₁) out of the resonant cavity and into one or more propagation modes supported by fiber 310. Within fibers 505 and 310, the signal spectrum may pump Raman spectrum having an associated peak wavelength (e.g., λᵣ₁), substantially as described above.

System 500 further includes fiber laser oscillator 522. Oscillator 522 may have an architecture similar to that of oscillator 521. In the example illustrated, oscillator 522 also includes a length of doped fiber 505 between strong fiber grating 507, and another output coupler 509, which is tuned to selectively couple a different signal spectrum of a predetermined peak wavelength (e.g., λₛ₂) out of the resonant cavity and into one or more propagation modes supported by fiber 311.

System 500 further includes any number of additional fiber laser oscillators 523. Oscillators 523 may each have an architecture similar to that of oscillator 521 and/or oscillator 522. Each additional oscillator includes a another output coupler 509, which is tuned to selectively couple a different signal spectrum of a predetermined peak wavelength (e.g., λₛᵢ) out of the resonant cavity and into one or more propagation modes supported by a fiber 512. Within each additional fiber oscillator 523, signal spectrum may pump another Raman spectrum having as associated peak wavelength (e.g., λᵣᵢ), substantially as described above.

System 500 further includes signal combiner 325, which may, for example, have any of the attributes described above in the context of fiber device 300. Signal combiner 325 is to output the combined signal into fiber 330, which may be further optically coupled to any destination. In the example illustrated, fiber 330 is optically coupled to process head 350.

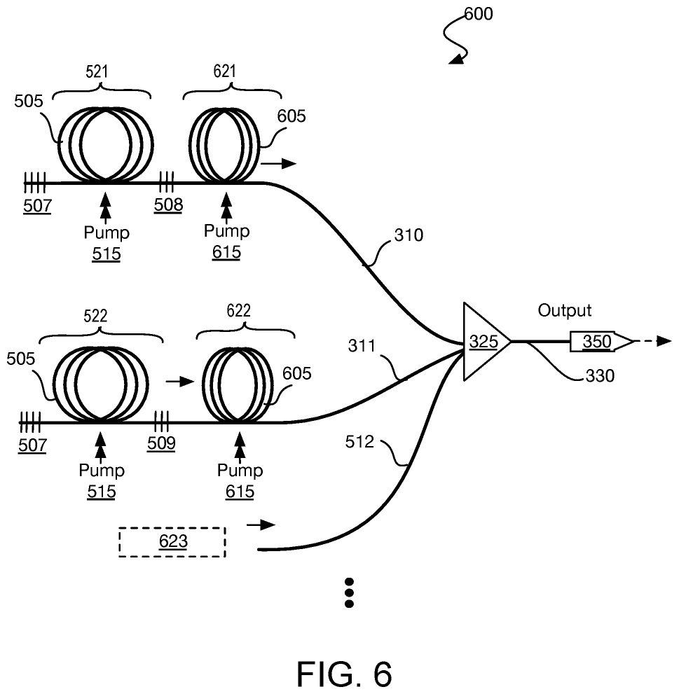

FIG. 6 is a schematic of a signal-combined MOPA system 600 having reduced Raman spectrum pumping, in accordance with some embodiments. Fiber laser system 600 comprises fiber laser oscillator 521 optically coupled to a fiber power amplifier 621 through output coupler 508. Oscillator 521 may have any of the attributes described above in the context of fiber system 500. Fiber amplifier 621 is to intensify at least the signal spectrum excited by oscillator 521. Fiber amplifier 621 is optically coupled to a pump light source 615, which may also be a solid state diode laser, or lamp, for example. Oscillator 521 and power amplifier 621 may be components of any MOPA module known to be suitable for signal-combined system architectures. Fiber amplifier 621 includes a length of doped fiber 605, which may have any of the properties described above for doped fiber 505. For example, in some embodiments, doped fiber 605 comprises rare-earth ions such as Er³⁺ (erbium), Yb³⁺ (ytterbium), Nd³⁺ (neodymium), Tm³⁺(thulium), Ho³⁺ (holmium), or the like, or any combination thereof. Doped fiber 605 may comprise a multi-clad fiber, for example substantially as described above for fiber 310. In some embodiments, doped fiber 605 comprises a multi-mode fiber supporting multiple propagation modes within a fiber core (e.g., substantially as described above for fiber 310). In some advantageous embodiments where doped fiber 505 comprises single-mode fiber capable of supporting only one guided propagation mode within the fiber core, doped fiber 605 comprises a multi-mode fiber capable of supporting multiple propagation modes within the fiber core.

In accordance with some MOPA embodiments, power amplifier 621 is positioned between an input of signal combiner 325 and output coupler 508. Power amplifier 621 may therefore amplify the uniquely tuned signal spectrum transmitted by output coupler 508. System 600 further includes one or more additional MOPA modules, each optical coupled into a port of signal combiner 325. In the illustrated example, another power amplifier 622 is positioned between an input of signal combiner 325 and output coupler 509. Power amplifier 622 may therefore amplify the uniquely tuned signal spectrum transmitted by output coupler 509. Optionally, system 600 may further one or more additional MOPA modules 623 coupled into signal combiner 325. Each additional MOPA module 623 may be tuned to different peak signal wavelengths such that each is sufficiently separated to have non-overlapping peak Raman wavelengths.

An output of signal combiner 325 is coupled into fiber 330, which may support one or more propagation modes to convey the combined signal to any suitable destination (e.g., process head 350). In further embodiments, signal combiner 325 may be between the tuned output couplers 508, 509 and one or more power amplification stage. For example, fiber 330 may be coupled into a power amplification stage (not depicted), which may amplify a band of a multimodal signal component including one or more peak wavelengths. Such an amplification stage may be in addition to power amplifiers 621, 622, or in the alternative to power amplifiers 621, 622.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure. It will be recognized that the invention is not limited to the embodiments so described, but can be practiced with modification and alteration without departing from the scope of the appended claims. The above embodiments may include the undertaking of only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

What is claimed is:

1. A signal-combined laser system, comprising:
at least one of a first fiber oscillator or a first fiber power amplifier to provide a first light beam of a first optical power to a first fiber, the first light beam to comprise a first signal spectrum having a first peak signal wavelength;
at least one of a second fiber oscillator or a second fiber power amplifier to provide a second light beam of a second optical power to a second fiber, the second light beam to comprise a second signal spectrum having a second peak signal wavelength, different than the first peak signal wavelength;
a signal combiner coupled to the first fiber and to the second fiber, the signal combiner to combine the first and second light beams, wherein the combined beam is to comprise:
a multimodal signal component including both the first peak wavelength and the second peak wavelength; and
a multimodal Raman component including a third peak wavelength Raman-shifted from the first peak wavelength, and a fourth peak wavelength Raman-shifted from the second peak wavelength.

2. The system of claim 1, wherein:
the first light beam is provided through a first fiber Bragg grating (FBG) having a highest transmission at the first peak signal wavelength; and
the second light beam is provided through a second fiber Bragg grating (FBG) having a highest transmission at the second peak signal wavelength.

3. The system of claim 2, wherein:
at least one of the first or second peak signal wavelengths is to be between 1000 nm and 1200 nm, and
the first and second peak signal wavelengths are to be separated by at least 5 nm.

4. The system of claim 3, wherein the first and second peak signal wavelengths are separated by less than a separation of the first and third peak signal wavelengths.

5. The system of claim 2, wherein:
the at least one of the first fiber oscillator or the first fiber amplifier comprises the first fiber laser oscillator;
the first fiber laser oscillator further comprises a first output coupler to provide the first light beam to the first fiber, and the first output coupler comprises the first FBG;
the at least one of the second fiber oscillator or second first fiber amplifier comprises the second fiber laser oscillator; and
the second fiber laser oscillator comprises a second output coupler to provide the second light beam to the second fiber, and the second output coupler comprises the second FBG.

6. The system of claim 1, wherein the multimodal signal component is to have a third optical power that is at least 2 kW.

7. The system of claim 6, wherein the first optical power and the second optical power are approximately equal.

8. The system of claim 1, wherein the multimodal Raman component is to have a fourth optical power that is a function of less than a sum of the first and second optical powers.

9. The system of claim 8, wherein the multimodal Raman component is to comprise a first band centered about the third peak wavelength, and the first band is to have an optical power that is a function of only the first optical power.

10. The system of claim 9, wherein the multimodal Raman component is to comprise a second Raman band centered about the fourth peak wavelength, and the second Raman band is to have a power that is a function of only the second optical power.

11. The system of claim 1, further comprising:
a delivery fiber coupled to the signal combiner to receive the combined beam; and
a process head coupled to the delivery fiber to propagate the combined beam into free space.

12. The system of claim 11, wherein:
the at least one of a first fiber oscillator or a first fiber power amplifier comprises both the first fiber oscillator and the first fiber power amplifier; and
the first fiber power amplifier is coupled between the delivery fiber and the first fiber oscillator.

13. The system of claim 12, wherein the first fiber power amplifier is coupled between the signal combiner and the first fiber oscillator.

14. A method of signal combining multiple laser sources, the method comprising:
providing a first signal component of a first light beam into a first fiber, wherein the first signal component has a first peak wavelength;
providing a second signal component of a second light beam into a second fiber, wherein the second signal component has a second peak wavelength;
forming a beam combination comprising the first and second signal components, wherein the beam combination comprises:
a multimodal signal component including both the first peak wavelength and the second peak wavelength; and
a multimodal Raman component including a third peak wavelength Raman-shifted from the first peak wavelength, and a fourth peak wavelength Raman-shifted from the second peak wavelength; and
propagating the beam combination within a third fiber.

15. The method of claim 14, further comprising:
generating, with a first fiber oscillator, the first light beam;
generating, with a second fiber oscillator, the second light beam; and
wherein the beam combination has an optical power of at least 2 kW.

16. The method of claim 15, wherein:
the providing of the first signal component is with an output coupler of the first fiber oscillator;
the output coupler of the first fiber oscillator comprises a first fiber grating having a highest transmission at the first peak signal wavelength;
the providing of the second signal component is with an output coupler of the second fiber oscillator; and
the output coupler of the second fiber oscillator comprises a second fiber grating having a highest transmission at the second peak signal wavelength.

17. The method of claim 14, wherein:
the first light beam has a first optical power; and
the second light beam has a second optical power, substantially equal to the first optical power.

18. The method of claim 17, wherein the multimodal Raman component has an optical power that is a function of less than a sum of the first and second optical powers.

19. The method of claim 18, wherein the multimodal Raman component comprises a first band centered about the third peak wavelength, and an optical power of the first band is a function of only the first optical power.

20. The method of claim 19, wherein the multimodal Raman component comprises a second Raman band centered about the fourth peak wavelength, and the second Raman band has an optical power that is a function of only the second optical power.

21. The method of claim 14, wherein:
at least one of the first or second peak signal wavelengths is between 1000 nm and 1200 nm, the first and second peak signal wavelengths are separated by at least 5 nm; and
the method further comprises:
propagating the beam combination from the signal combiner to a process head with a third fiber; and
propagating the beam combination from the process head into free space.
